(19) United States
(12) Patent Application Publication
(10) Pub. No.: US 2016/0273654 A1
(43) Pub. Date: Sep. 22, 2016

(54) GASKET AND SEALING STRUCTURE

(71) Applicant: NOK CORPORATION, Minato-ku, Tokyo (JP)

(72) Inventor: Nan YU, Aso-shi, Kumamoto (JP)

(21) Appl. No.: 15/034,413

(22) PCT Filed: Oct. 28, 2014
(86) PCT No.: PCT/JP2014/078540

§ 371 Date: May 4, 2016

(30) Foreign Application Priority Data
Nov. 7, 2013 (JP) 2013-231493

(51) Int. Cl. F16J 15/02; F16L 21/02; F16J 15/06

(52) U.S. Cl. CPC F16J 15/025; F16J 15/062; F16L 21/02

(57) ABSTRACT

Provided is a gasket and a sealing structure capable of achieving an improvement in sealing performance against the gas having solubility to the rubber material without adversely affecting the assembly workability. A gasket (100) includes a gasket main body portion (110) that is compressed toward an opposing surface (620) by an end surface (510) in a device (500); a first annular convex portion (120) that protrudes from the gasket main body portion (110) toward the device (500), is compressed toward the opposing surface (620) by a chamfered portion (530), and is constituted by a curved surface tapered toward a tip thereof; and a second annular convex portion (130) that protrudes from the gasket main body portion (110) to an inner peripheral surface side, and is compressed toward radially outwardly by a body portion (610).

### CROSS-REFERENCE TO RELATED APPLICATIONS

This application is a National Stage of International Application No. PCT/JP2014/078540, filed Oct. 28, 2014, which claims priority to Japanese Application No. 2013-231493, filed Nov. 7, 2013. The entire disclosures of each of the above applications are incorporated herein by reference.

### FIELD

The present disclosure relates to a gasket and a sealing structure for preventing leakage of gas having solubility to a rubber material such as CFC gas or hydrogen gas.

### BACKGROUND

A gasket is provided at a place to which pipe for supplying gas is mounted in order to prevent gas leakage (see Patent Literatures 1 and 2). With reference to FIG. 6, a sealing structure according to a conventional example will be described. FIG. 6 is a schematic cross-sectional view of the sealing structure according to the conventional example.

In a device 500 to which pipe 600 is mounted, an insertion hole 520 is provided which is opened in an end surface 510 on a side to which the pipe 600 is mounted. In addition, in the pipe 600, a body portion 610 which is inserted into the insertion hole 520, and an opposing surface 620 which opposes the end surface 510 in the device 500 are provided. Further, a chamfered portion 530 is provided between the end surface 510 and an inner peripheral surface of the insertion hole 520 in the device 500. A rubber gasket 700 is fitted in an annular gap having a substantially triangular cross section which is formed by the chamfered portion 530, the body portion 610, and the opposing surface 620. In general, an 0 ring having a circular cross section is used as the gasket 700.

With the configuration described above, it is possible to prevent gas supplied into the device 500 from the pipe 600 from leaking to the outside through a gap between the body portion 610 and the insertion hole 520.

However, in the case where the gas supplied by the pipe is CFC gas or hydrogen gas, the gas has solubility to a rubber material. In this case, the gas may be transmitted through the gasket and leak to the outside. In the case where the transmission quantity of the gas transmitted through the rubber gasket is q, the diffusion coefficient of the rubber material is D, the solubility coefficient of the rubber material is S, a gas pressure difference between the inside and the outside of the gasket is Pa−Pb, the transmission area of the gasket is A, the transmission length of the gasket is L, and time is t, the following expression is satisfied.

q=D×S×(Pa−Pb)×(A+L)×t

Consequently, in order to reduce the transmission quantity q by changing the shape of the gasket, (A+L) may be reduced appropriately. In order to realize this, it is conceivable to form the cross-sectional shape of the gasket into an L-shaped cross section. However, in this case, although the transmission quantity q can be reduced, another problem may arise. This point will be described with reference to FIGS. 7 and 8. Each of FIGS. 7 and 8 is a schematic cross-sectional view showing the sealing structure according to an imaginary technique.

A gasket 800 shown in the drawings includes a cylindrical portion 810 which seals an annular gap between the insertion hole 520 of the device 500 and the body portion 610 of the pipe 600, and a flat portion 820 that seals a gap between the end surface 510 of the device 500 and the opposing surface 620 of the pipe 600. Accordingly, the cross section of the gasket 800 (a cross section including the central axis) is L-shaped. According to the thus configured gasket 800, it is possible to reduce the transmission area A and increase the transmission length L, thereby making it possible to reduce (A+L).

However, in the case of this imaginary technique, a problem arises that it is difficult to stably maintain sealing performance, and that assembly workability is poor. That is, as shown in FIG. 7, due to dimensional deviations, the relative position of the device 500 with respect to the pipe 600 may be the position indicated by L1 in FIG. 7, in this case a gap is formed, or the position indicated by L2 in FIG. 7, in this case there is a possibility that the gasket 800 is excessively compressed and damaged. Consequently, it is necessary to increase positioning accuracy between the device 500 and the pipe 600 and dimensional accuracy of the gasket 800, otherwise it becomes difficult to stably maintain the sealing performance. In addition, a problem also arises that, when the body portion 610 of the pipe 600 is inserted into the insertion hole 520 of the device 500, the end edge of an opening portion of the insertion hole 520 may abut on the gasket 800 (see an arrow X in FIG. 8), and thus the assembly workability is poor.

### CITATION LIST

### Patent Literature

Patent Literature 1: Japanese Patent Application Laid-open No. 2007-170570

Patent Literature 2: Japanese Patent Application Laid-open No. 2001-165320

### SUMMARY

### Technical Problem

An object of the present disclosure is to provide a gasket and a sealing structure capable of achieving an improvement in sealing performance against the gas having solubility to the rubber material without adversely affecting the assembly workability.

### Solution To Problem

The present disclosure has adopted the following means in order to solve the above problems.

The gasket of the present disclosure is a gasket, that is annular and made of rubber, for preventing gas leakage by sealing a gap between a first member and a second member, the first member having an end surface and an insertion hole opened in the end surface and being formed with a chamfered portion between the end surface and an inner peripheral surface of the insertion hole, the second member having an opposing surface opposing the end surface and a body portion inserted into the insertion hole, the gasket including: a gasket main body portion that is compressed toward the opposing surface by the end surface in the first member; a first annular convex portion that protrudes from the gasket main body portion toward the first member, is compressed toward the opposing surface by the chamfered portion, and is constituted by a curved surface tapered toward a tip thereof; and a second annular convex portion that protrudes from the gasket main body portion to an inner peripheral surface side, and is compressed toward radially outwardly by the body portion.

In addition, the sealing structure of the present disclosure is a sealing structure including: a first member having an end surface and an insertion hole opened in the end surface and being formed with a chamfered portion between the end surface and an inner peripheral surface of the insertion hole; a second member having an opposing surface opposing the end surface and a body portion inserted into the insertion hole; and a gasket that is annular and made of rubber, and seals a gap between the first member and the second member to prevent gas leakage, wherein the gasket comprises: a gasket main body portion that is compressed toward the opposing surface by the end surface in the first member; a first annular convex portion that protrudes from the gasket main body portion toward the first member, is compressed toward the opposing surface by the chamfered portion, and is constituted by a curved surface tapered toward a tip thereof; and a second annular convex portion that protrudes from the gasket main body portion to an inner peripheral surface side, and is compressed toward radially outwardly by the body portion.

According to these aspects of the disclosure, not only the portion compressed by the chamfered portion (the first annular convex portion) and the portion compressed by the body portion (the second annular convex portion) but also the gasket main body portion compressed by the end surface in the first member is provided. Consequently, as compared with the case of the gasket such as an O ring which is fitted in an annular gap having a substantially triangular cross section, it is possible to reduce the transmission area A of the gas through the gasket and increase the transmission length L. Accordingly, it becomes possible to reduce the transmission quantity of the gas which is transmitted through the gasket to prevent the gas leakage.

In addition, the first annular convex portion compressed by the chamfered portion is constituted by the curved surface tapered toward the tip. Consequently, in the process of assembling the first member and the second member, a space is formed, within a space formed by the chamfered portion, the body portion, and the opposing surface, into which the first annular convex portion enters when the first annular convex portion is deformed. Accordingly, an appropriate compressibility of the first annular convex portion can be maintained, thereby making it possible to maintain a stable sealing performance even when a positional relationship between the first member and the second member and dimensional accuracy of the gasket vary to some extent. In addition, workability during the first member and the second member are assembled is not adversely affected.

Herein, the gasket main body portion may be compressed by an annular member disposed between the opposing surface and the gasket main body portion or an annular protruding portion formed on the opposing surface, and the end surface in the first member, and the gasket may further comprise a third annular convex portion that protrudes from the gasket main body portion toward an annular gap between the body portion and the annular member or the annular protruding portion, and is spaced apart from the opposing surface in a state before being compressed by the first member, and comes into close contact with the opposing surface when compressed by the first member.

Accordingly, when the first annular convex portion is compressed, a large compressive force does not act on the first annular convex portion until the third annular convex portion abuts on the opposing surface, and hence it is possible to further prevent the first annular convex portion from being excessively compressed.

### Advantageous Effects of the Disclosure

As described thus far, according to the present disclosure, it becomes possible to achieve the improvement in sealing performance against the gas having solubility to the rubber material without adversely affecting the assembly workability.

### DRAWINGS

FIG. 1 is a partially cutaway cross-sectional view of a gasket according to Example 1 of the present disclosure.

FIG. 2 is a schematic cross-sectional view showing a sealing structure according to Example 1 of the present disclosure.

FIG. 3 is a partially cutaway cross-sectional view of a gasket according to Example 2 of the present disclosure.

FIG. 4 is a schematic cross-sectional view showing a sealing structure according to Example 2 of the present disclosure.

FIG. 5 is a schematic cross-sectional view showing a sealing structure according to a modification of Example 2 of the present disclosure.

FIG. 6 is a schematic cross-sectional view of a sealing structure according to a conventional example.

FIG. 7 is a schematic cross-sectional view showing a sealing structure according to an imaginary technique.

FIG. 8 is a schematic cross-sectional view showing the sealing structure according to the imaginary technique.

### DETAILED DESCRIPTION

Hereinafter, modes for carrying out the present disclosure will be exemplarily described in detail based on examples thereof with reference to the drawings. However, the dimensions, materials, shapes, relative arrangements and so on of constituent parts described in the examples are not intended to limit the scope of the present disclosure to these alone in particular unless specifically described. In Examples described below, a description will be given of the case of a sealing structure in which a gasket for preventing gas leakage is provided at a place to which pipe for supplying gas is mounted. However, the present disclosure is not limited to the mounting portion of the pipe, but can also be applied to a gasket and a sealing structure that seal a gap between two members (a first member and a second member) provided in various devices.

### Example 1

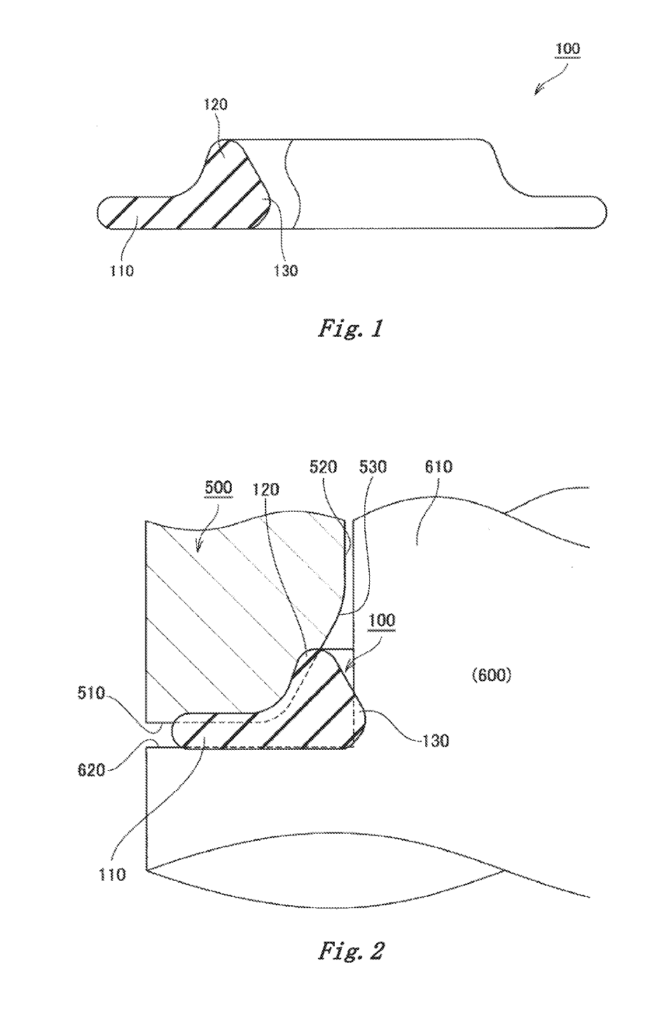

With reference to FIGS. 1 and 2, a gasket and a sealing structure according to Example 1 of the present disclosure will be described. FIG. 1 is a partially cutaway cross-sectional view of the gasket according to Example 1 of the present disclosure. FIG. 2 is a schematic cross-sectional view showing the sealing structure according to Example 1 of the present disclosure.

### Gasket

With reference to FIG. 1 in particular, a gasket 100 according to the present Example will be described. The gasket 100 according to the present Example is suitably used for preventing leakage of gas having solubility to a rubber material such as CFC gas or hydrogen gas. The gasket 100 is constituted by an annular member made of rubber.

The gasket 100 is constituted by an annular and flat gasket main body portion 110, a first annular convex portion 120 which protrudes from the gasket main body portion 110 in an upward direction in FIG. 1, and a second annular convex portion 130 which protrudes from the gasket main body portion 110 to an inner peripheral surface side. The first annular convex portion 120 is constituted by a curved surface which protrudes toward a tip thereof. More specifically, the first annular convex portion 120 is configured such that its outer peripheral surface side is constituted by a tapered surface of which the diameter is reduced with approach to the tip, its inner peripheral surface side is constituted by another tapered surface of which the diameter is increased with approach to the tip, and intersecting portions of the pair of the tapered surfaces are connected to each other with a curved surface having an arc-shaped cross section. Further, as a specific example, the taper angle of the tapered surface of the outer peripheral surface side of the first annular convex portion 120 can be set to 40 degrees, and the taper angle of the tapered surface of the inner peripheral surface side can be set to 60 degrees. In addition, a tip of the second annular convex portion 130 is also preferably formed into a curved surface having an arc-shaped cross section. The present Example adopts a configuration in which the curved surface having the arc-shaped cross section in the second annular convex portion 130 and the tapered surface of the inner peripheral surface side in the first annular convex portion 120 are connected to each other without a step.

### Sealing Structure

With reference to FIG. 2 in particular, the sealing structure according to the present Example will be described. The sealing structure according to the present Example is the structure in which the gasket 100 is provided at a place of a device 500 as the first member to which a pipe 600 as the second member is mounted. In FIG. 2, a state of the gasket 100 before deformation is shown in order to clarify the dimensional relationship among the gasket 100, the device 500, and the pipe 600.

Hereinbelow, the sealing structure will be described in greater detail. In the device 500 to which the pipe 600 is mounted, an insertion hole 520 which is formed in an end surface 510 on a side to which the pipe 600 is mounted is provided. In addition, in the pipe 600, a body portion 610 which is inserted into the insertion hole 520 and an opposing surface 620 which opposes the end surface 510 in the device 500 are provided. In the present Example, the body portion 610 and the portion provided with the opposing surface 620 in the pipe 600 are integrally provided. However, the opposing surface 620 may be provided in another member different from the body portion 610 by fixing the other member to the body portion 610.

Each of an outer peripheral surface of the body portion 610 and an inner peripheral surface of the insertion hole 520 is constituted by a cylindrical surface. In addition, a chamfered portion 530 is provided between the end surface 510 and the inner peripheral surface of the insertion hole 520 in the device 500. The chamfered portion 530 is constituted by a tapered surface of which the diameter is reduced with approach to the inside of the insertion hole 520 from the end surface 510.

The gasket main body portion 110 in the gasket 100 is compressed toward the opposing surface 620 of the pipe 600 by the end surface 510 of the device 500. In the present Example, the gasket main body portion 110 is compressed by the end surface 510 and the opposing surface 620. The first annular convex portion 120 in the gasket 100 is configured to protrude from the gasket main body portion 110 toward the device 500. The first annular convex portion 120 is compressed toward the opposing surface 620 of the pipe 600 by the chamfered portion 530 of the device 500. In the present Example, the first annular convex portion 120 is compressed by the chamfered portion 530 and the opposing surface 620. The inner diameter of the tip of the second annular convex portion 130 in the gasket 100 is set to be smaller than the outer diameter of the body portion 610 of the pipe 600. Accordingly, the second annular convex portion 130 is compressed to an outer side in a radial direction by the body portion 610. Note that the second annular convex portion 130 exerts not only sealing performance with respect to the outer peripheral surface of the body portion 610 but also a function of preventing the gasket 100 from falling off from the body portion 610 in a state before the pipe 600 is mounted to the device 500.

### Advantages of Gasket and Sealing Structure of Present Example

According to the gasket 100 of the present Example, not only the portion compressed by the chamfered portion 530 of the device 500 (the first annular convex portion 120) and the portion compressed by the body portion 610 of the pipe 600 (the second annular convex portion 130) but also the gasket main body portion 110 compressed by the end surface 510 of the device 500 is provided. Consequently, as compared with the case of the gasket such as an O ring which is fitted in an annular gap having a substantially triangular cross section, it is possible to reduce a transmission area A of the gas through the gasket 100, and increase a transmission length L. Accordingly, it becomes possible to reduce the transmission quantity of the gas which is transmitted through the gasket 100 to prevent gas leakage.

In addition, the first annular convex portion 120 compressed by the chamfered portion 530 of the device 500 is configured by the curved surface which is tapered toward the tip. Accordingly, a gap is secured in between the first annular convex portion 120, the chamfered portion 530, and the body portion 610.

Consequently, in the process of mounting the pipe 600 to the device 500 (the process of assembling), a space is formed, within the space formed by the chamfered portion 530, the body portion 610, and the opposing surface 620, into which the first annular convex portion 120 enters when the first annular convex portion 120 is deformed. Accordingly, an appropriate compressibility of the first annular convex portion 120 can be maintained, and a filling ratio of the gasket 100 in the space formed by the chamfered portion 530, the body portion 610, and the opposing surface 620 is maintained appropriately. Consequently, even when a positional relationship between the device 500 and the pipe 600 and dimensional accuracy of the gasket 100 vary to some degree, stable sealing performance is maintained. In addition, workability when the device 500 and the pipe 600 are assembled is not adversely affected.

Thus, according to the gasket 100 and the sealing structure of the present Example, it becomes possible to achieve an improvement in sealing performance against the gas having solubility to the rubber material without adversely affecting assembly workability.

### Example 2

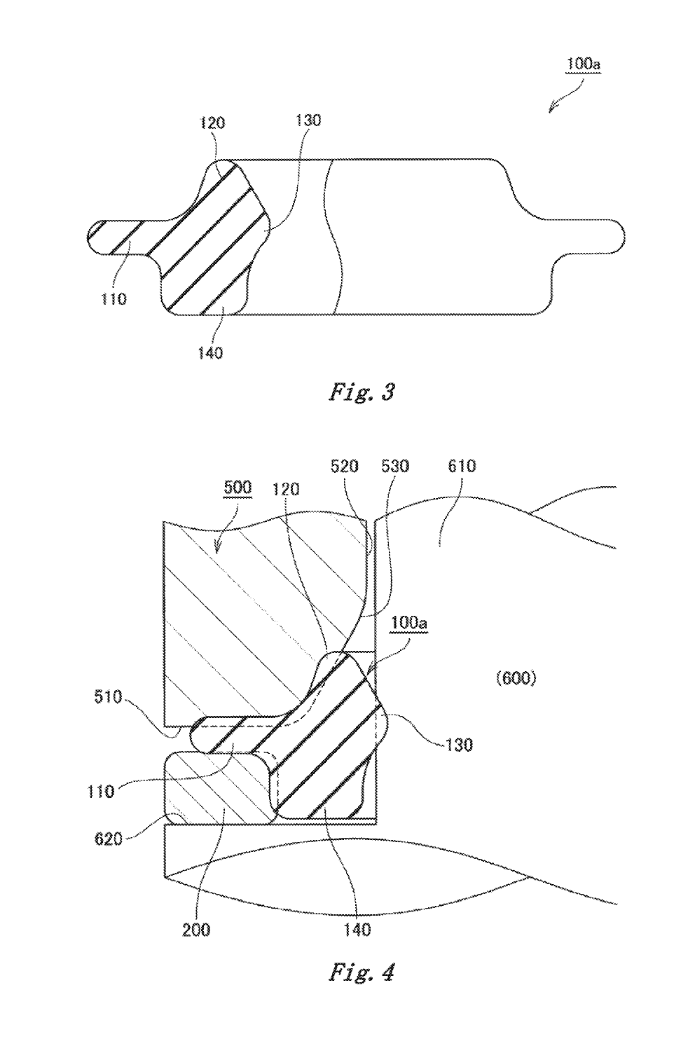

Example 2 of the present disclosure is shown in FIGS. 3 and 4. In the gasket and the sealing structure according to the present Example as well, the basic configuration and functions thereof are the same as those in Example 1, and hence the same constituent parts are designated by the same reference numerals as those in Example 1, and the description thereof will be appropriately omitted. FIG. 3 is a partially cutaway cross-sectional view of the gasket according to Example 2 of the present disclosure. FIG. 4 is a schematic cross-sectional view showing the sealing structure according to Example 2 of the present disclosure.

### Gasket

With reference to FIG. 3 in particular, a gasket 100a according to the present Example will be described. Similarly to the case of Example 1, the gasket 100a according to the present Example is suitably used for preventing leakage of gas having solubility to a rubber material such as CFC gas or hydrogen gas. In addition, similarly to the case of Example 1, the gasket 100a is constituted by an annular member made of rubber.

Similarly to the case of Example 1, the gasket 100a includes the gasket main body portion 110, the first annular convex portion 120, and the second annular convex portion 130. The configurations thereof are the same as those in the case of Example 1 described above, and hence the description thereof will be omitted. In the gasket 100a according to the present Example, a third annular convex portion 140 is provided which protrudes from the gasket main body portion 110 in a downward direction in FIG. 3.

### Sealing Structure

With reference to FIG. 4 in particular, the sealing structure according to the present Example will be described. Similarly to the case of Example 1 described above, the sealing structure according to the present Example is also the structure in which the gasket 100a is provided at the portion of the device 500 as the first member to which the pipe 600 as the second member is mounted. In FIG. 4, a state of the gasket 100a before deformation is shown in order to clarify the dimensional relationship among the gasket 100a, the device 500, and the pipe 600.

The configuration of the device 500 and the configuration of the pipe 600 are the same as those in Example 1 described above, and hence the description thereof will be omitted. In the present Example, an annular member 200 is disposed between the opposing surface 620 in the pipe 600 and the gasket main body portion 110 of the gasket 100a. The annular member 200 is formed of a metal or a resin material so as to prevent the transmission of CFC gas or hydrogen gas.

The gasket main body portion 110 in the gasket 100a according to the present Example is compressed toward the opposing surface 620 of the pipe 600 by the end surface 510 of the device 500. In the present Example, the gasket main body portion 110 is compressed by the end surface 510 and the annular member 200. In addition, the first annular convex portion 120 in the gasket 100a is configured to protrude from the gasket main body portion 110 toward the device 500. Further, the first annular convex portion 120 is compressed toward the opposing surface 620 of the pipe 600 by the chamfered portion 530 of the device 500. The inner diameter of the tip of the second annular convex portion 130 in the gasket 100a is set to be smaller than the outer diameter of the body portion 610 of the pipe 600. Accordingly, the second annular convex portion 130 is compressed to the outer side in the radial direction by the body portion 610. Note that the second annular convex portion 130 exerts not only the sealing performance with respect to the outer peripheral surface of the body portion 610 but also a function of preventing the gasket 100 from falling off from the body portion 610 in a state before the pipe 600 is mounted to the device 500.

In the gasket 100a according to the present Example, the third annular convex portion 140 which protrudes from the gasket main body portion 110 toward an annular gap between the body portion 610 of the pipe 600 and the annular member 200 is provided. The third annular convex portion 140 is configured to be spaced apart from the opposing surface 620 in the pipe 600 in a state before the gasket 100a is compressed by the device 500, and come into close contact with the opposing surface 620 when the gasket 100a is compressed by the device 500. Consequently, the portion provided with the first annular convex portion 120 and the portion provided with the third annular convex portion 140 in the gasket 100a are compressed by the chamfered portion 530 in the device 500 and the opposing surface 620 in the pipe 600. Note that the outer diameter of the third annular convex portion 140 is set to be larger than the inner diameter of the annular member 200. Accordingly, by fitting the annular member 200 to the gasket 100a, it becomes possible to handle these portions as one part.

In the thus configured gasket 100a and sealing structure according to the present Example as well, it is possible to obtain the same functions and effects as those in the case of Example 1 described above. In addition, in the case of the present Example, when the first annular convex portion 120 is compressed, a large compressive force does not act on the first annular convex portion 120 until the third annular convex portion 140 abuts on the opposing surface 620. Consequently, as compared with the case of Example 1, it is possible to further prevent the first annular convex portion 120 from being excessively compressed.

### Modification

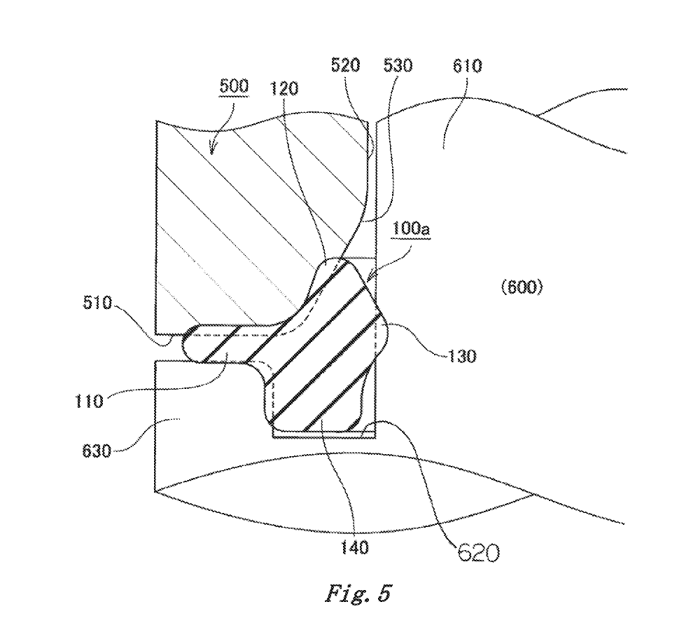

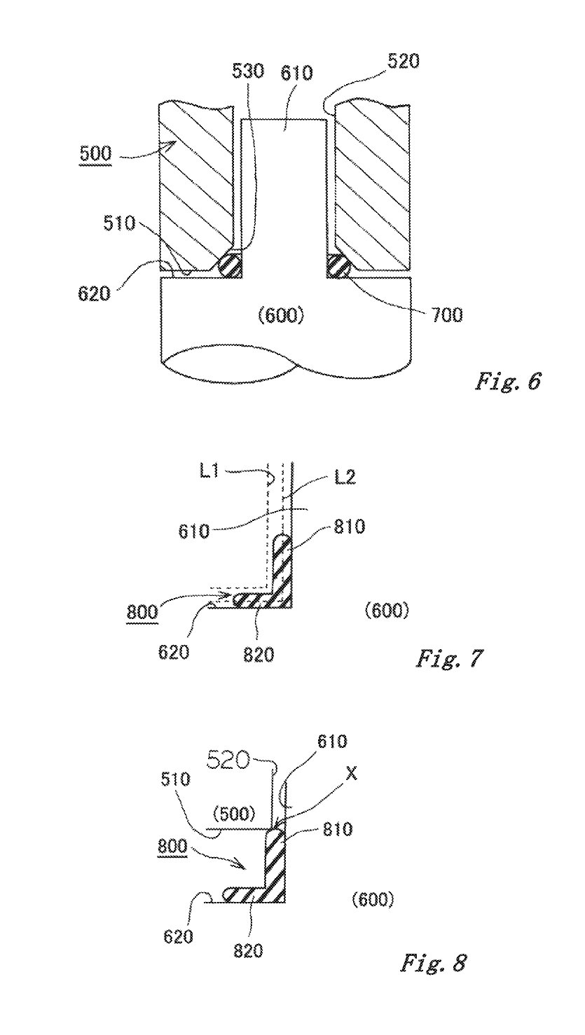

With reference to FIG. 5, a modification of Example 2 described above will be described. FIG. 5 is a schematic cross-sectional view showing the sealing structure according to the modification of Example 2 of the present disclosure. In this modification, instead of the annular member 200 in Example 2 described above, an annular protruding portion 630 which protrudes toward the device 500 is formed on the opposing surface 620 in the pipe 600. Note that the configuration other than the configuration in which the annular protruding portion 630 is provided instead of the annular member 200 is the same as that described in Example 2. It will be easily appreciated that the same functions and effects as those in the case of Example 2 described above can be obtained in the present Example as well.

### REFERENCE SIGNS LIST

100, 100a: Gasket
110: Gasket main body
120: First annular convex portion
130: Second annular convex portion
140: Third annular convex portion
200: Annular member
500: Device
510: End surface
520: Insertion hole
530: Chamfered portion
600: Pipe
610: Body portion
620: Opposing surface
630: Annular protruding portion

1. A gasket, that is annular and made of rubber, for preventing gas leakage by sealing a gap between a first member and a second member, the first member having an end surface and an insertion hole opened in the end surface and being formed with a chamfered portion between the end surface and an inner peripheral surface of the insertion hole, the second member having an opposing surface opposing the end surface and a body portion inserted into the insertion hole, the gasket comprising:
a gasket main body portion that is compressed toward the opposing surface by the end surface in the first member;
a first annular convex portion that protrudes from the gasket main body portion toward the first member, is compressed toward the opposing surface by the chamfered portion, and is constituted by a curved surface tapered toward a tip thereof; and
a second annular convex portion that protrudes from the gasket main body portion to an inner peripheral surface side, and is compressed toward radially outwardly by the body portion.

2. The gasket according to claim 1, wherein the gasket main body portion is compressed by an annular member disposed between the opposing surface and the gasket main body portion or an annular protruding portion formed on the opposing surface, and the end surface in the first member, and
the gasket further comprises a third annular convex portion that protrudes from the gasket main body portion toward an annular gap between the body portion and the annular member or the annular protruding portion, and is spaced apart from the opposing surface in a state before being compressed by the first member, and comes into close contact with the opposing surface when compressed by the first member.

3. A sealing structure comprising:
a first member having an end surface and an insertion hole opened in the end surface and being formed with a chamfered portion between the end surface and an inner peripheral surface of the insertion hole;
a second member having an opposing surface opposing the end surface and a body portion inserted into the insertion hole; and
a gasket that is annular and made of rubber, and seals a gap between the first member and the second member to prevent gas leakage, wherein the gasket comprises:
a gasket main body portion that s compressed toward the opposing surface by the end surface in the first member;
a first annular convex portion that protrudes from the gasket main body portion toward the first member, is compressed toward the opposing surface by the chamfered portion, and is constituted by a curved surface tapered toward a tip thereof; and
a second annular convex portion that protrudes from the gasket main body portion to an inner peripheral surface side, and is compressed toward radially outwardly by the body portion.

4. The sealing structure according to claim 3 further comprising an annular member disposed between the opposing surface and the gasket main body portion,
wherein the gasket main body portion is compressed by the end surface in the first member and the annular member, and
the gasket further comprises a third annular convex portion that protrudes from the gasket main body portion toward an annular gap between the body portion and the annular member, and is spaced apart from the opposing surface in a state before being compressed by the first member, and comes into close contact with the opposing surface when compressed by the first member.

5. The sealing structure according to claim 3, wherein an annular protruding portion that protrudes toward the first member is formed on the opposing surface,
the gasket main body portion is compressed by the end surface in the first member and the annular protruding portion, and
the gasket further comprises a third annular convex portion that protrudes from the gasket main body portion toward an annular gap between the body portion and the annular protruding portion, and is spaced apart from the opposing surface in a state before being compressed by the first member, and comes into close contact with the opposing surface when compressed by the first member.
